(19) United States
(12) Patent Application Publication
(10) Pub. No.: US 2001/0053454 A1
(43) Pub. Date: Dec. 20, 2001

(54) Laminated film and structure comprising same

(76) Inventors: Kenichi Higashi, Sodegaura-shi (JP); Yousuke Tsukuda, Osaka (JP)

Correspondence Address: BIRCH STEWART KOLASCH & BIRCH, PO BOX 747, FALLS CHURCH, VA, 22040-0747, US

(21) Appl. No.: 09/842,248

(22) Filed: Apr. 26, 2001

(30) Foreign Application Priority Data
Apr. 28, 2000 (JP) 2000-130151

(51) Int. Cl. B32B 27/08; B29C 45/14; B29C 45/16

(52) U.S. Cl. 428/520; 428/516; 428/517; 264/511; 264/510; 264/513; 264/259

(57) ABSTRACT

There are disclosed:

(1) a laminated film comprising:

(i) a resin layer (A) containing an acrylic resin, and

(ii) a resin layer (B) containing a resin composition,

which composition comprises:

(a) 10 to 98% by weight of a propylene polymer,

(b) 1 to 60% by weight of an inorganic filler, and

(c) 1 to 60% by weight of a thermoplastic elastomer;

(2) a structure comprising the laminated film and a substrate containing a polyolefin resin; and

(3) a process for producing the structure.

### FIELD OF THE INVENTION

The present invention relates to a laminated film comprising (i) a resin layer containing an acrylic resin and (ii) another resin layer containing a specific resin composition; a structure comprising (i) said laminated film and (ii) a substrate containing a polyolefin resin; and car exterior or interior parts and household electric appliance parts composed of said structure.

### BACKGROUND OF THE INVENTION

As a process for improving appearance property of a resin molded article without painting thereof, there is recently proposed a process (cf. JP-A 2-503077 and JP-A 11-207896) for laminating a laminated film having superior appearance property on said resin molded article, which process comprises the steps of:

(1) thermoforming (for example, vacuum forming) a laminated film having a surface layer such as a decorated film layer and a colored film layer, and having superior appearance property, to obtain a molded laminated film having a form adapted to the form of an injection mold used in the following step (2),

(2) fixing the molded laminated film closely on an inner surface of a cavity of the injection mold so as to contact said surface layer having superior appearance property with an inner surface of the cavity, and

(3) injecting a synthetic resin into the mold to form a substrate, whereby obtaining a structure wherein the laminated film is laminated on a part of the substrate surface.

As the resin for forming the substrate in the above-mentioned process, a polyolefin resin such as polypropylene is generally used. In order to obtain a substrate having properties such as scratch resisting property, glossing property and weather resisting property, it is proposed to use a laminated film, whose outermost layer is a transparent or colored layer containing an acrylic resin, and whose innermost layer faced to a substrate is a layer containing a polypropylene resin.

### SUMMARY OF THE INVENTION

The present inventors have found that when the above-mentioned laminated film, which comprises a layer containing an acrylic resin and a layer containing a polypropylene resin, is applied to the above-mentioned step (1), a molded laminated film obtained in this step easily deforms, for example, curls with the lapse of time, and as a result, it is very difficult to apply the molded laminated film to the above-mentioned step (2), or the resulting structure, even if obtained, has inferior appearance property.

Accordingly, it is an object of the present invention to provide a laminated film, which is prevented markedly from deforming with the lapse of time as mentioned above.

It is another object of the present invention to provide a structure comprising said laminated film and a substrate containing a polyolefin resin.

It is a further object of the present invention to provide a process for producing said structure.

It is a still further object of the present invention to provide car exterior or interior parts and household electric appliance parts, which are composed of said structure.

The present inventors have undertaken extensive studies to accomplish the above-mentioned objects. As a result, it has been found that the above-mentioned objects can be accomplished by using a laminatedfilm comprising a layer containing a specific resin composition, and thereby the present invention has been obtained.

The present invention provides a laminated film comprising:

(i) a resin layer (A) containing an acrylic resin, and

(ii) aresin layer (B) containing aresin composition, which composition comprises:

(a) 10 to 98% by weight of a propylene polymer,

(b) 1 to 60% by weight of an inorganic filler, and

(c) 1 to 60% by weight of a thermoplastic elastomer, provided that the sum of the components (a), (b) and (c) is 100% by weight.

The present invention also provides a structure comprising the above-mentioned laminated film and a substrate containing a polyolefin resin, wherein the substrate is bound to the resin layer (B) of the laminated film.

The present invention further provided a process for producing a structure, which comprises the steps of:

(1) thermoforming the above-mentioned laminated film to obtain a molded laminated film having a form adapted to the form of an injection mold of the following step (2),

(2) fixing the molded laminated film closely on an inner surface of a cavity of the injection mold so as to contact the resin layer (A) of the molded laminated filmwith the inner surface of the cavity, and

(3) injecting a polyolefin resin into the mold to form a substrate, whereby obtaining a structure wherein the resin layer (B) side of the laminated film is bound to the substrate.

The present invention still further provides car exterior or interior parts and household electric appliance parts, which are composed of the structure mentioned above.

### BRIEF DESCRIPTION OF THE DRAWINGS

FIG. 1 is a strabismus figure of a molded laminated film, which is obtained by molding a laminated film in accordance with the present invention using a vacuum forming machine.

### DETAILED DESCRIPTION OF THE INVENTION

An “acrylic resin” used in the present invention means:

(i) a polymer containing a structure unit derived from at least one monomer selected from the group consisting of acrylic acid, methacrylic acid, an acrylic acid ester and a methacrylic acid ester, the structure unit being hereinafter referred to as “monomer unit”, and

(ii) a resin, which is obtained by modifying the above-mentioned polymer, and contains 3 to 30% by weight of a 6 -membered ring acid anhydride unit having the following formula [I] in the molecule, provided that a weight of the polymer unmodified is 100% by weight.

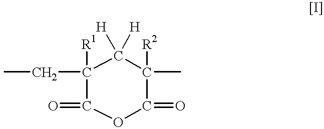

In the above formula, R¹ and R² are independently of each other a hydrogen atom or an alkyl group having 1 to 5 carbon atoms, and may be the same or different from each other. Examples of the alkyl group are methyl, ethyl, propyl, i-propyl, butyl, t-butyl, sec-butyl and amyl groups.

Examples of the foregoing acrylic acid ester are methyl acrylate and ethyl acrylate, and examples of the methacrylic acid ester are methyl methacrylate, ethyl methacrylate, cyclohexyl methacrylate and benzyl methacrylate.

The modified polymer having the 6-membered ring acid anhydride unit represented by the above formula [I] can be obtained by, for example, heat-treating a polymer containing a methacrylic acid ester unit at a temperature of from 150 to 350° C., and preferably from 220 to 320° C. in the presence of a basic compound such as sodium hydroxide, potassium hydroxide and sodium methyl late. How to produce the modified polymer is disclosed in, for example, JP-A 1-103612. The above-defined content of the 6-membered ring acid anhydride unit is determined so as to make heat resistance of the modified polymer higher than that of the unmodified polymer, and so as not to make a melt viscosity of the modified polymer so high that there are caused troubles on moldability thtereof. A preferred content thereof is from 5 to 25% by weight.

The acrylic resin mentioned above is preferably a combination (i.e. a resin composition) of 95 to 50 parts by weight of an acrylic resin having a glass transition temperature of 60 to 110° C. and a weight average molecular weight of 70,000 to 600,000, and 5 to 50 parts byweight of an acrylic resin containing a core-shell structure having a layer of rubber elasticity, provided that the sum of both is 100 parts by weight, wherein the above-mentioned weight average molecular weight is measured by gel permeation chromatography and expressed in terms of a weight average molecular weight of poly methyl methacrylate.

As the above-mentioned acrylic resin containing a core-shell structure having a layer of rubber elasticity, for example, the following polymers (1) and (2) are enumerated:

(1) an acrylic polymer having a two-layered structure, wherein an inner layer thereof is a layer of rubber elasticity comprising a copolymer of a C₄ to C₈ alkyl ester of acrylic acid with a poly-functional monomer, and an outer layer thereof is a layer comprising a hard polymer containing a methyl methacrylate unit as a main component, and

(2) an acrylic polymer having a three-layered structure, wherein an innermost layer thereof is a layer comprising a hard polymer containing a methyl methacrylate unit as a main component, an intermediate layer is a layer of rubber elasticity comprising a copolymer of a C₄ to C₈ alkyl ester of acrylic acid with a poly-functional monomer, and an outermost layer thereof is a layer comprising a hard polymer containing a methyl methacrylate unit as a main component. These polymers can be produced according to a process described in, for example, JP-B 55-27576.

The acrylic resin may be used in combination with other resins such as a fluorine-containing resin (for example, a poly vinylidene fluoride resin) and amethacrylate-styrene resin (MS resin); hindered phenol antioxidants; well-known antioxidants such as phosphorus antioxidants and sulfur antioxidants; weather resisting agents such as ultraviolet ray absorbers and hindered amine photo-stabilizers; flame retarders; coloring agents; pigments; dyes; and inorganic fillers.

As the ultraviolet ray absorbers, benztriazole and benzophenone ultraviolet ray absorbers can generally be used singly or in combination thereof. Of these, a high molecular weight benztriazole ultraviolet ray absorber such as 2,2-methylenebis[4-(1,1,3,3-tetramethylbutyl)-6-(2H-benztri azol-2-yl)phenol] is preferable from a viewpoint of preventing the absorber from volatilizing out of the laminated film obtained and preventing the other layer in the laminated film from deteriorating. Particularly, a content of the ultraviolet absorber in the outermost layer in the laminated film is preferably not less than 1000 ppm.

The resin layer (A) may be uni-layered or multi-layered. Examples of the uni-layered resin layer are a transparent layer comprising the acrylic resin, and a colored layer comprising the acrylic resin containing a coloring agent. Examples of the multi-layered resin layer are:

(i) a resin layer having at least two layers of a transparent layer containing the acrylic resin, and a colored layer containing the acrylic resin having a coloring agent; and

(ii) a resin layer having at least three layers of a transparent layer containing the acrylic resin, a printed layer having a printed surface and a colored layer containing the acrylic resin having a coloring agent in this order.

The above-mentioned coloring agent is not particularly limited in kind, and may be any of an inorganic pigment and an organic pigment. Examples of the pigment are carbon black, titanium oxide, kaolin clay, zinc white, iron oxide red, permanent red, molybdate orange, cobalt blue, ultramarine blue, phthalocyanine blue and manganese violet. These pigments may be used singly or in combination of two or more. In addition, the pigments may be used in combination with aluminum flake or pearl pigment to obtain a metallic tone or a pearl tone, or may be used in combination with a dye.

When the resin layer (A) comprises a printed layer, a printing method is not particularly limited, and can be carried out in a conventional manner. For example, there are enumerated a method of gravure printing, a method of screen printing and a method making use of a computer graphic technology with an ink-jet printer. Ink used is not also particularly limited and includes, forexample, urethane ink, vinyl acetate/acrylate ink and water-color ink.

When the resin (A) comprises at least two layers of a transparent layer and a colored layer, or comprises at least three layers of a transparent layer, aprinted layer and a colored layer, it is usually recommendable to dispose the transparent layer as an outermost layer of the laminated film. A laminate film, which has a transparent layer having a high transparency peculiar to the acrylic resin as an outermost layer, can provide a structure, wherein a surface of an inner colored layer, asurface of an inner printed layer and a surface of a substrate containing any lustrous material therein can be seen to have markedly superior deep feeling. Therefore, a resin layer, which comprises a transparent layer containing the acrylic resin, is preferable as the resin layer (A).

The resin layer (A) can be obtained by forming a resin comprising the acrylic resin into a film according to a molding method such as T die extrusion molding method and calendaring method. From a viewpoint of thickness accuracy and surface smoothness of the film obtained, preferred are an extrusion molding method carried out under contacting both surfaces of the film with the surface of a roll, and another extrusion molding method carried out under contacting both surfaces of the film with the surface of a metal belt. It is recommendable to arrange a screen mesh such as a metal made screen mesh and a sintering ceramics made screen mesh at a passage of a molten acrylic resin in order to prevent foreign substances from entering the film obtained, because any foreign substances give unfavorable effects to appearance and printability of the film obtained, even when foreign substances having a particle size of not more than 100 μm exist in the film obtained. A preferred screen mesh is arotary type screen changer manufactured by Gneuss in Germany, because plugging hardly occurs, or even when plugging occurs, it is not frequent to discontinue the production step for removing the plugged matter. By using said rotary type screen changer, it is possible to obtain a film containing substantially no foreign substance having a particle size of not more than 100 μm.

A thickness of the resin layer (A) measured by a micrometer is usually from 30 to 700μm, preferably from 100 to 500 μm, and more preferably from 200 to 400 μm. When the resin layer (A) comprises a transparent layer and a colored layer, a thickness of the transparent layer is usually from 10 to 300 μm, and preferably from 30 to 150 μm. A thickness of the colored layer is usually from 20 to 400 μm, and preferably from 70 to 250 μm.

For example, the resin layer (A) having two layers of a transparent layer and a colored layer can be produced according to a multi-layer extrusion method, wherein a transparent layer and a colored layer are extruded at the same time, or such resin layer (A) can be produced by binding a transparent layer and a colored layer with each other, wherein respective layers of the transparent layer and the colored layer are prepared separately in advance. Alternatively, the resin layer (A) can be produced in a manner such that either a transparent layer or a colored layer is obtained in the form of a molten film according to an extrusion molding method, and the other layer prepared separately is put thereon to be bound, and immediately thereafter the bound product is contacted with a roll surface or a belt surface.

The resin layer (B) is provided in order to prevent the laminated film from curling at the time of thermoforming thereof.

A “propylene polymer” used in the present invention means a polymer containing 50 to 100% by weight of a propylene unit. Examples of the propylene polymer are a homopolymer of propylene and a copolymer of propylene with at least one olefin selected from the group consisting of ethylene and α-olefins having 4 to 18 carbon atoms. Examples of the α-olefins are butene-1, 4-methyl-pentene-1, hexene-1, octene-1, decene-1 and octadecene-1. Examples of the above-mentioned copolymer are propylene-ethylene block copolymer, propylene-ethylene random copolymer, propylene-butene-1 copolymer and propylene-ethylene-butene-1 terpolymer. The propylene polymer may be used singly or in combination of two or more. A preferred propylene polymer is propylene-ethylene random copolymer.

The propylene polymer may be used in combination with other polymers. A preferred combination is that of a propylene homopolymer with an ethylene polymer such as a low density polyethylene and a linear low density polyethylene.

How to obtain the propylene polymer is not particularly limited, and the propylene polymer can be obtained according to, for example, an ion polymerization process.

A content of the propylene polymer in the resin composition used for forming the resin layer (B) is from 10 to 98% by weight, preferably from 15 to 80% by weight, and more preferably from 20 to 70% by weight, from a viewpoint of preventing the laminated film from curling at the time of thermoforming thereof.

As an inorganic filler used in the present invention, there are enumerated, for example, talc, calcium carbonate, mica, barium sulfate, calcium silicate, clay, magnesium carbonate, alumina, silica and glass fiber. Of these, talc is preferred.

A content of the inorganic filler in the resin composition used for forming the resin layer (B) is from 1 to 60% by weight, preferably from 10 to 50% by weight, and more preferably from 16 to 50% by weight, from a viewpoint of preventing the laminated film from shrinking during or after thermoforming thereof.

As a thermoplastic elastomer used in the present invention, there are enumerated, for example, an ethylene- α-olefin copolymer such as ethylene-propylene copolymer and ethylene-propylene-conjugated diene copolymer, which contains an ethylene unit and an α-olefin unit such as a propylene unit; and a styrene unit-containing copolymer such as styrene-butadiene-styrene block copolymer, styrene-isoprene-styrene block copolymer and styrene-ethylene-butylene-styrene block copolymer. Of these, an ethylene-α-olef in copolymer is preferred. As the α-olefin other than propylene, there are enumerated, for example, butene- 1, 4-methyl-pentene-1, hexene-1, octene-1, decene-1 and octadecene-1. The thermoplastic elastomer may be used singly or in combination of two or more.

A content of the thermoplastic elastomer in the resin composition used for forming the resin layer (B) is from 1 to 60% by weight, and preferably from 10 to 50% by weight, from a viewpoint of preventing the laminated film from shrinking during or after thermoforming thereof and of keeping rigidity of the resin layer (B) low.

Here, the sum of the inorganic filler and the thermoplastic elastomer in the resin composition used for forming the resin layer (B) is preferably from 20 to 80% by weight from a viewpoint of preventing the laminated film from shrinking during or after thermoforming thereof and of keeping rigidity of the resin layer (B) in a preferred range. When the sum exceeds 80% by weight, processability of the laminated film may not be good.

How to obtain the resin layer (B) is not particularly limited, and the resin layer (B) can be obtained according to a process such as an extrusion T die processing process known in the art. A thickness of the resin layer (B) is not particularly limited, and is preferably from 10 to 500 μm.

How to produce the laminated film in accordance with the present invention is not particularly limited. As a process therefor, there is enumerated, for example, a process wherein the resin layer (A) and the resin layer (B) are bound with each other using an adhesive. The adhesive is not particularly limited in kind. For example, known adhesives such as chlorinated polypropylene and dry laminating adhesives including those of polyester, polyurethane and polyacrylate types are enumerated.

How to bind the resin layer (A) with the resin layer (B) with each other is not particularly limited. As aprocess therefor, there are enumerated, for example, a process wherein the resin layer (A) and the resin layer (B), which are separately formed according to extrusion molding, are bound with each other, and a process wherein the resin (A) or the resin (B), which is in a molten state immediately after the extrusion molding, and the resin layer (B) or the resin layer (A), which is not in a molten state, are bound with each other.

The adhesive may be coated on either the resin layer (A) or the resin layer (B). From aviewpoint of increasing an adhesion strength, it is recommendable to subject the surface of the resin layer (B) to corona discharge treatment at a corona discharge density of 75 to 150 W min/m² before coating of the adhesive. Alternatively, from the same viewpoint as above, it is also recommendable to blow ozone on the surface of the resin layer (B) under condition of 5 to 50 mg/m². A temperature of the surface treated by ozone-blowing is usually from 180 to 340 ° C., preferably from 220 to 320° C., and more preferably from 250 to 300° C.

A “polyolefin resin” used for the substrate of the structure means a homoplymer of an olefin having 2 to 20 carbon atoms and a copolymer of at least two of said olefins. These polymers may be used singly or in combination of two or more. A preferred polyolefin resin is that capable of being molded according to an injection molding method.

Examples of the above-mentioned olefin are ethylene, propylene, butene-1, 4-methyl-pentene-1, pentene-1, hexene-1, octene-1, decene-1 and octadecene-1.

Examples of the polyolef in resin are polyethylene resin; the above-mentioned propylene polymer which can be used for the resin layer (B); polybutene; poly-4-methyl-penetene-1; propylene-ethylene block copolymer; and propylene-ethylene-butene-1 block copolymer.

The above-mentioned “polyethylene resin” means a homopolymer of ethylene and a copolymer of at least one of olefins having 3 to 20 carbon atoms with ethylene, whose ethylene unit content is from 50 to 98% by weight. These polymers may be used singly or in combination of two or more.

Examples of the polyethylene resin are a low density polyethylene produced according to a radical polymerization; a high density polyethylene produced according to an ion polymerization; and an ethylene-α-olef in copolymer produced by copolymerizing ethylene and an α-olefin according to aradical polymerization or an ion polymerization. Examples of the α-olefin are butene-1, 4-methyl-pentene-1, hexene-1, octene-1, decene-1 and octadecene-1.

The polyolefin resin may be used in combination with a polymer such as a styrene elastomer and an inorganic filler such as talc.

From a viewpoint of obtaining a structure having a low mold shrinkage, preferred is a combination of 95 to 60% by weight of a polyolefin resin having a coefficient of linear thermal expansion of not more than 1.0×10⁻⁴ (1/° C.) and 5 to 40% by weight of an inorganic filler such as talc. Here, the sum of both is 100% by weight.

The polyolefin resin can be produced in a conventional manner, and as a polymerization catalyst used therefor, for example, solid catalysts and metallocene catalysts are enumerated.

A structure in accordance with the present invention comprises the above-mentioned laminated film and the above-mentioned substrate, provided that the resin layer (B) in the laminated film and the substrate are bound with each other. How to produce the structure is not limited. There can be exemplified a process comprising the steps of:

(1) thermoforming the above-mentioned laminated film to obtain a molded laminated film having a form adapted to the form of an injection mold of the following step (2),

(2) fixing the molded laminated film closely on an inner surface of a cavity of the injection mold so as to contact the resin layer (A) of themolded laminatedfilmwith the inner surface of the cavity, and

(3) injecting a polyolefin resin into the mold to form a substrate, whereby obtaining a structure wherein the resin layer (B) side of the laminated film is bound to the substrate.

As the thermoforming method in the above-mentioned step (1), for example, a vacuum molding method, a press molding method and a vacuum press molding method are enumerated.

In the step (2), when the resin layer (A) comprises a transparent layer, it is recommendable to fix the molded laminated film closely on an inner surface of a cavity of the injection mold so as to contact the transparent layer with an inner surface of the cavity.

There is enumerated another process for producing the structure, which comprises the steps of:

(i) fixing the molded laminated film closely on an inner surface of a cavity of an in-moldable injection mold provided with an apparatus of delivering the laminated film, an apparatus of heating the same and an apparatus of drawing the same such as a vacuum-pumping suction apparatus, and

(ii) injection-molding the polyolefin resin.

In addition, there is enumerated a process for producing the structure, which comprises the steps of:

(i) extruding the polyolefin resin through dies, or injecting it inside of a mold consisting of a pair of male and female to form the substrate, and

(ii) binding the substrate with the laminated film.

A shape of the structure in accordance with the present invention is not limited. Examples thereof are that of car exterior or interior parts, that of household electric appliance parts, and a signboard like shape.

Since the resin layer (B) comprises the resin composition as mentioned above, said layer has a good adhesive property with the substrate containing the polyolefin resin, and as a result, a good appearance property of the structure can be kept for a long period of time.

Since the surface of the structure in accordance with the present invention comprises the resin layer (A) containing the acrylic resin, the structure has a good superior transparency and a superior surface glossing property. According to the present invention, there can be obtained a structure having a 60° specular gloss of not lower than 80%, and preferably not lower than 90% measured according to JIS-K-7105.

In order to substitute a conventional structure needing any painting with the structure in accordance with the present invention, the present structure is required to satisfy not only a good appearance property but also a scratch resisting property (pencil hardness). According to the present invention, a structure having a pencil hardness of not less than B, not less than 2H, and moreover not less than 4H can be obtaind, only by using an acrylic resin having a superior scratch resistance as the acrylic acid contained in the resin layer (A). In a word, according to the present invention, a structure having both a superior surface appearance property and a superior surface scratch resisting property can be obtained.

The structure in accordance with the present invention is suitable for uses such as car exterior or interior parts, household electric appliance parts, general merchandise parts and signboards. Particularly when the structure in accordance with the present invention is applied to uses such as car exterior or interior parts and household electric appliance parts, these parts can be obtained at a low cost, because painting to give appearance property thereto is not required. When the structure in accordance with the present invention has a plate like shape, said structure can be punched with a punching blade to be applied to uses such as signboards having any form, because said structure comprises the polyolefin resin having high toughness.

Examples

The present invention is illustrated with reference to Examples, which are not to be considered as limiting the scope of the present invention.

Example 1

(1) Acrylic polymer (a)

As an acrylic resin (a) for a transparent layer to form the resin layer (A), a copolymer pellet having a reduced viscosity of 0.08 L/g was used, which copolymer was produced according to a bulk polymerization, and comprised 94% by weight of a methyl methacrylate unit and 6% by weight of a methyl acrylate unit. The copolymer was used in combination with a benztriazole ultraviolet ray absorber, ADEKASTAB LA31, manufactured by Asahi Denka Kogyo K. K. in an amount of 0.5 part by weight based on 100 parts by weight of the copolymer.

(2) Acrylic polymer (b)

As a resin for a colored layer to form the resin layer (A), a pellet was used, which pellet was obtained by melt-kneading 97.99 parts by weight of an acrylic polymer (b) pellet, 2 parts by weight of an aluminum powder having an average particle size of 38μm, manufactured by Toyo Aluminium K. K., and 0.01 part by weight of a titanium yellow dye at a resin temperature of 265° C. using a 40 mm single screw extruder manufactured by Tanabe plastic Machine Co., Ltd., wherein the acrylic polymer (b) pellet was prepared by blending the following three components (b-1) to (b-3) with a tumbler mixer, followed by melt-kneading with a twin screw extruder:

(b-1) 40 parts by weight of a copolymer pellet having a reduced viscosity of 0.06 L/g, which copolymer was obtained according to a bulk polymerization, and comprised 95% by weight of a methyl methacrylate unit and 5% by weight of a methyl acrylate unit,

(b-2) 40 parts by weight of a three-layered structure fine powder having an average particle size of about 300 nm, which fine powder was obtained according to Example 3 of JP-B 55-27576, and comprised (i) an innermost layer containing a cross-linked polymer having from 37.5 parts by weight of methyl methacrylate and 0.075 part by weight of diallyl maleate, (ii) an intermediate layer containing a soft rubbery elastomer having from 38.5 parts by weight of butyl acrylate, 9 parts by weight of styrene and 0.95 part by weight of allyl maleate, and (iii) an outermost layer containing a copolymer having from 14.4 parts by weight of methyl methacrylate and 0.6 part by weight of ethyl acrylate, and

(b-3) 20 parts by weight of a copolymer bead having a reduced viscosity of 0.06 L/g, which bead was obtained according to a suspension polymerization, and comprised 90% by weight of methyl methacrylate and 10% by weight of methyl acrylate.

(3) Production of resin layer (A)

A resin layer (A) was produced continuously according to a process comprising the steps of:

(i) melting and extruding the acrylic polymer (a) through a single screw extruder kept at 260° C. to obtain a molten film, and melting and extruding the colored acrylic polymer (b) through another single screw extruder kept at 260° C. to obtain a molten film,

(ii) laminating the obtained two extruded molten films with each other using a feed block kept at 280° C., and extruding the resulting laminate through a T die kept at 280° C., and

(iii) cooling the extruded laminate by inserting the extruded laminate between two rolls so that both surfaces of the extruded laminate contact with respective surfaces of a first roll and a second roll of three polishing rolls (all kept at 70° C) to obtain the resin layer (A) comprising a transparent layer having a thickness of 100μm and a colored layer having a thickness of 200μm.

(4) Production of resin layer (B)

A resin composition comprising the following components (i) to (iii) was subjected to dry blend, and thereafter the resulting dry blended rein composition was molded using a T-die film processing machine kept at 260° C. to obtain a resin layer

(B) having a 200 mμ thickness:

(i) 27 parts by weight of a propylene-ethylene copolymer (hereinafter referred to as “PP-1”), a trademark of SUMITOMO NOBLENFH1016, manufactured by Sumitomo Chemical Co., Ltd., which copolymer had an ethylene unit content of 15% by weight, and had a melt flow rate of 0.5 g/10 min under a load of 2.16 kg at 230° C.,

(ii) 30 parts by weight of an ethylene-butene copolymer (hereinafter referred to as “EBR-1”), a trademark of ESPRENE SPO N0416, manufactured by Sumitomo Chemical Co., Ltd., which copolymer had a butene unit content of 22% by weight, and had a melt flow rate of 13 g/10 min under a load of 2.16 kg at 230° C., and

(iii) 43 parts by weight of a talc master batch, which comprised 30% by weight of a propylene homopolymer (hereinafter referred to as “PPMB”) having a melt flow rate of 120 g/10 min under a load of 2.16 kg at 230° C., and 70% by weight of talc, a trademark of TALK JR46, manufactured by Hayashi Kasei K. K.

(5) Adhesive

A mixture of 100 parts by weight of a polyurethane adhesive, a trademark of TKS 3989, manufactured by Toyo Morton, Ltd., and 4 parts by weight of an isocyanate hardener, a trademark of CAT-RT, manufactured by Toyo Morton, Ltd., was diluted with toluene so as to make an application quantity of 7 g/m², and the diluted solution was used.

(6) Production of laminated film

The adhesive mentioned in the above (5) was coated on the colored layer side of the resin layer (A) mentioned in the above (3) so as to make an after-drying application quantity of 3 g/m². After drying at 80° C. for about 1 minute, the resultant was bound to the surface of the resin layer (B) mentioned in the above (4), which surface had been corona-treated, using a laminate roll kept at 90° C., and the resulting laminate was aged at 40° C. for 72 hours to obtain a laminated film having a layer structure of transparent layer/colored layer/adhesive layer/resin layer (B).

(7) Molding of laminated film

The laminated film obtained in the above (6) was vacuum-molded according to a process comprising the steps of:

(i) fixing the laminated film obtained in the above (6) in a heating zone of a vacuum-molding machine, a trademark of CUPF 1015-PWB, manufactured by Fuseshinku Co., Ltd.,

(ii) heating both surfaces of the laminated film using an infrared heater until temperature of respective surfaces reached 180° C.,

(iii) contacting a mold with the heated laminated film,

(iv) vacuum-molding the laminated film by sucking air between the mold and the laminated film using a vacuum pump, and

(v) cooling and solidifying the molded laminated film using a blower to obtain a molded laminated film.

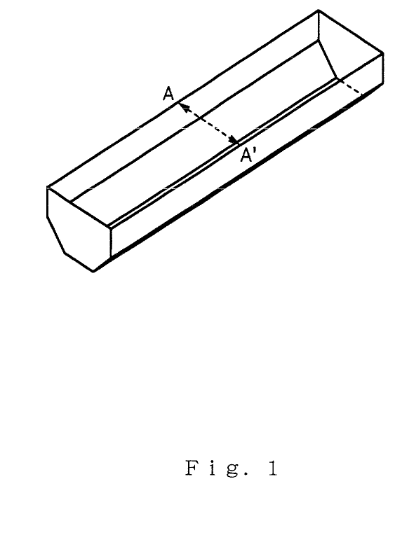

The molded laminated film is as shown in FIG. 1.

(8) Evaluation of curling property

The molded laminated film obtained in the above (7) was trimmed along its shape, and was put horizontally on a table for one week. Thereafter, a degree of curling was determined according to the following expression (cf. FIG. 1), wherein the length of the mold corresponding to distance A-A′ of molded laminated film was 34 mm. The results are shown in Table 1.

Degree of curling

[length of mold corresponding to distance A-A′ of molded laminated film] - [length of distance A-A′ of molded laminated film]

Example 2

Example 1 was repeated to obtain a molded laminated film, except that PP-1 was replaced by a propylene-ethylene copolymer (hereinafter referred to as “PP-2”), a trademark of SUMITOMO NOBLEN S131, manufactured by Sumitomo Chemical Co., Ltd., which copolymer had an ethylene unit content of 5% by weight, and had a melt flow rate of 1.5 g/10 min under a load of 2.16 kg at 230 ° C. Then, a curling property thereof was evaluated. The results are shown in Table 1.

Example 3

Example 1 was repeated to obtain a molded laminated film, except that EBR-1 was replaced by an ethylene-propylene copolymer (hereinafter referred to as “EPR-1”), a trademark of ESPRENE SPO V0141, manufactured by Sumitomo Chemical Co., Ltd., which copolymer had a propylene unit content of 53% by weight, and had a melt flow rate of 1.2 g/10 min under a load of 2.16 kg at 230° C. Then, a curling property thereof was evaluated. The results are shown in Table 1.

Example 4

Example 1 was repeated to obtain a molded laminated film, except that amounts of PP-1, EBR-1 and the talc master batch were changed to 21 parts by weight, 15 parts by weight and 64 parts by weight, respectively. Then, a curling property thereof was evaluated. The results are shown in Table 1.

Example 5

Example 1 was repeated to obtain a molded laminated film, except that the acrylic polymer (b) was used in place of the acrylic polymer (a) as the transparent layer of the resin layer (A). Then, a curling property thereof was evaluated. The results are shown in Table 1.

Comparative Example 1

Example 1 was repeated to obtain a molded laminated film, except that a resin layer (B) consisting of only the above-mentioned PP-2 was used as the resin layer (B). Then, a curling property thereof was evaluated. The results are shown in Table 1.

Comparative Example 2

Example 1 was repeated to obtain a molded laminated film, except that a resin composition consisting of 57 parts by weight of the above-mentioned PP-2 and 43 parts by weight of the talc master batch was used as a resin composition for the resin layer (B). Then, a curling property thereof was evaluated. The results are shown in Table 1.

Reference Example 1

Only the resin layer (A) in Example 1 was vacuum molded in the same manner as in Example 1, and then a curling property thereof was evaluated. The results are shown in Table 1.

The “vacuum moldability” in Table 1 was evaluated on the basis of a range of vacuum molding temperature, at which neither lines nor poor mold-transf er was observed on the film obtained; and the case where the temperature range was wide is marked with ◯ and the case where the temperature range was narrower than that is marked with Δ, and the case where the temperature range was much narrower than that is marked with X.

Using the laminated films obtained in Examples 1 to 5 and Comparative Examples 1 and 2, respective structures were produced. When the laminated f ilms obtained in Examples 1 to 5 were used, structures having a superior appearance property and scratch resisting property were obtained. On the other hand, when the laminated films obtained in Comparative Examples 1 and 2 were used, in all cases, a part of the laminated film was buried in the substrate, and therefore, structures having a superior appearance property were not obtained.

TABLE 1

| | | | | | | | Comparative | Comparative | Reference |
|---|---|---|---|---|---|---|---|---|---|
| | | Example 1 | Example 2 | Example 3 | Example 4 | Example 5 | Example 1 | Example 1 | Example 1 |
| Resin layer (A) | | | | | | | | | |
| Acrylic polymer for | | (a) | (a) | (a) | (a) | (b) | (a) | (a) | (a) |
| transparent layer | | | | | | | | | |
| Acrylic polymer for | | (b) | (b) | (b) | (b) | (b) | (b) | (b) | (b) |
| colored layer | | | | | | | | | |
| Resin layer (B) | PP-1 | 27 | — | 27 | 21 | 27 | — | — | — |
| (parts by wt.) | PP-2 | — | 27 | — | — | — | 100 | 57 | — |
| | EBR-1 | 30 | 30 | — | 15 | 30 | — | — | — |
| | EPR-1 | — | — | 30 | — | — | — | — | — |
| | PPMB | 13 | 13 | 13 | 19 | 13 | — | 13 | — |
| | talc | 30 | 30 | 30 | 45 | 30 | — | 30 | — |

| | | | | | | | | |
|---|---|---|---|---|---|---|---|---|
| Vacuum moldability | ◯ | ◯ | ◯ | ◯ | ◯ | Δ | ◯ | X |
| Curling property (mm) | 0 | 0 | 0 | 5 | 0 | 19 | 14 | 0 |

1. A laminated film comprising:
(i) a resin layer (A) containing an acrylic resin, and
(ii) aresin layer (B) containinga resin composition, which composition comprises:
(a) 10 to 98% by weight of a propylene polymer,
(b) 1 to 60% by weight of an inorganic filler, and
(c) 1 to 60% by weight of a thermoplastic elastomer, provided that the sum of the components (a), (b) and (c) is 100% by weight.

2. The laminated film according to claim 1, wherein the resin layer (A) contains a transparent layer or a colored layer.

3. The laminated f ilm according to claim 1, wherein the resin layer (A) contains at least two layers of a transparent layer and a colored layer, wherein the transparent layer is an outermost layer.

4. The laminated film according to claim 1, wherein the thermoplastic elastomer contains an ethylene-α-olefin copolymer.

5. The laminated film according to claim 1, wherein the inorganic filler contains talc.

6. A structure comprising:
(I) a laminated film, which comprises:
(i) a resin layer (A) containing an acrylic resin, and
(ii) a resin layer (B) containing aresin composition, which composition comprises:
(a) 10 to 98% by weight of a propylene polymer,
(b) 1 to 60% by weight of an inorganic filler, and
(c) 1 to 60% by weight of a thermoplastic elastomer, provided that the sum of the components (a), (b) and (c) is 100% by weight; and
(II) a substrate containing a polyolefin resin, wherein the substrate is bound to the resin layer (B) of the laminated film.

7. The structure according to claim 6, wherein the polyolefin resin contains a propylene polymer.

8. A process for producing a structure, which comprises the steps of:
(1) thermoforming a laminated film comprising:
(i) a resin layer (A) containing an acrylic resin, and
(ii) a resin layer (B) containing a resin composition, which composition comprises:
(a) 10 to 98% by weight of a propylene polymer,
(b) 1 to 60% by weight of an inorganic filler, and
(c) 1 to 60% by weight of a thermoplastic elastomer, provided that the sum of the components (a), (b) and (c) is 100% by weight, to obtain a molded laminated film having a form adapted to the form of an injection mold of the following step (2),
(2) fixing the molded laminated film closely on an inner surface of a cavity of the injection mold so as to contact the resin layer (A) of the molded laminated filmwith the inner surface of the cavity, and
(3) injecting a polyolefin resin into the mold to form a substrate, whereby obtaining a structure wherein the resin layer (B) side of the laminated film is bound to the substrate.

9. Car exterior or interior parts composed of the structure according to claim 6.

10. Household electric appliance parts composed of the structure according to claim 6.
